(19) United States
(12) Patent Application Publication
(10) Pub. No.: US 2025/0003205 A1
(43) Pub. Date: Jan. 2, 2025

(54) Drain Clearing Tool for Pressurized HVAC Systems

(71) Applicant: F. W. Webb Company, Bedford, MA (US)

(72) Inventor: John Lyons Meyer, Moosup, CT (US)

(73) Assignee: F. W. Webb Company, Bedford, MA (US)

(21) Appl. No.: 18/748,559

(22) Filed: Jun. 20, 2024

Related U.S. Application Data
(60) Provisional application No. 63/523,826, filed on Jun. 28, 2023.

(51) Int. Cl. E03F 9/00

(52) U.S. Cl. CPC E03F 9/005

(57) ABSTRACT

A drain cleaning system and method for use with a drain of an active process containing pressurized process fluid, includes a housing couplable in a fluid-tight manner to the drain of the active system, the housing supporting a mechanical cleaning tool and a pressurized gas cleaning tool, to engage and clear blockages from the drain. A liquid capture assembly is coupled in a fluid-tight manner to the housing, to receive and contain process fluid exiting from the drain during operation of the mechanical and pressurized gas cleaning tools.

### RELATED APPLICATION

This application claims the benefit of U.S. Provisional Patent Application Ser. No. 63/523,826, entitled DRAIN CLEARING TOOL FOR HVAC SYSTEMS, filed on Jun. 28, 2023, the contents of which are incorporated herein by reference in their entirety for all purposes.

### BACKGROUND

### Technical Field

This invention relates to maintenance of pressurized fluid flow lines, and more particularly to a system that permits the safe and controlled clearing of plugged drain valves in pressurized fluid flow lines of commercial, industrial, or institutional HVAC systems.

### Background Information

Closed-loop fluid systems can develop thick, dense deposits of scale and sludge if the fluid is not properly maintained and replaced. These deposits settle in the low points of system piping, which often is where the system drain points are located. Deposits may also form in the drain points of heating and cooling coils, heat exchangers, and fan coils. When these deposits reach a certain thickness, cleaning often requires removal of the drains and removal of the process fluid from the HVAC system.

Glycol is a water-miscible coolant used in chiller-based cooling systems. The two main types are ethylene glycol and propylene glycol. When the drains of these systems become clogged, the systems must be serviced, which typically involves pumping out the spent glycol into a vacuum truck, flushing the system, collecting the water with a vacuum truck, and transferring a fresh supply of corrosion-inhibited glycol mixture to the boiler or chiller system, disposing of the combined spent glycol and flush water at a properly licensed facility. This fluid removal is time consuming and results in system downtime that is often unplanned and inconvenient.

Alternatively, attempting to service blocked drains while the process is in operation may result in uncontrolled releases of fluid, particularly when the blocked drain is under static pressure from fluid contained in the process upstream of the drain point. If the fittings are badly corroded, they may break off during removal, resulting in an uncontrolled release of heat transfer fluid. Even if the fittings are in good condition and do not require removal, clearing the blockage without the means to contain the flow may result in a short but pressurized release of fluid, risking exposure to workers and the surrounding environment.

It is therefore desirable to provide an improved system and method for clearing drains of pressurized processes, that addresses the above-described issues.

### SUMMARY

The appended claims may serve as a summary of the invention.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a partially exploded plan view of a representative embodiment of a drain clearing system of the present invention; and

FIG. 2 is partially exploded plan view of an alternate embodiment of the system of FIG. 1.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the scope of the present invention. In addition, well-known structures and techniques have not been shown in detail in order not to obscure the understanding of this description. The following detailed description is, therefore, not to be taken in a limiting sense, and the scope of the present invention is defined by the appended claims and their equivalents.

As used in the specification and in the appended claims, the singular forms “a”, “an”, and “the” include plural referents unless the context clearly indicates otherwise. For example, reference to “an analyzer” includes a plurality of such analyzers. In another example, reference to “an analysis” includes a plurality of such analyses.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

Briefly described, embodiments of the present invention include a drain cleaning system 10, 10′ that is attachable to a wide variety of low-point drain fittings 40 and allow for blockages to be removed by both mechanical and pressurized gas while at the same time controlling and containing pressurized process (e.g., heat transfer) fluid during and after the blockage removal. These embodiments thus advantageously control and capture the flow from the drain 40 while obstructions in the drain are being cleared, to substantially prevent uncontrolled release of the process fluid.

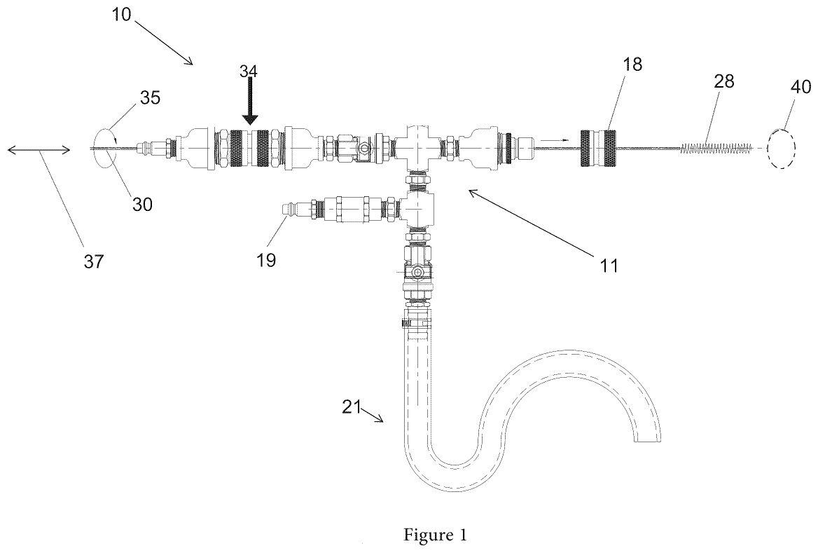

Referring now to the appended Figures, embodiments of the present invention will now be described in detail. Turning to FIG. 1, in particular embodiments, a drain cleaning system 10 is provided for use with a drain of an active process containing pressurized process fluid. The system 10 includes a housing 11 couplable in a fluid-tight manner to the drain 40 (shown schematically in phantom) of the active system. The housing supports both a mechanical cleaning tool 30 and a pressurized gas cleaning tool 19 to engage and clear blockages from the drain 40. A liquid capture assembly 21 is coupled in a fluid-tight manner to the housing 11 to receive process fluid exiting from the drain 40 during operation of the mechanical cleaning tool 30 and/or the pressurized gas cleaning tool 19.

In particular embodiments, housing 11 includes a process attachment fitting 18 (shown in an exploded view relative to housing 11) sized and shaped for fluid-tight engagement with the drain 40. Pressurized gas cleaning tool 19 includes gas-tight (optionally quick-connect) fitting for operatively engaging a compressed gas (e.g., air) source. Once engaged to the gas source, pressurized gas passes from housing 11 into drain 40 to engage and help clear blockages therein. Mechanical cleaning tool 30 includes a physical device such as a probe or conventional drain auger or drain snake that passes from housing 11 into the drain 40 to physically engage blockages therein. Mechanical cleaning tool/probe 30 optionally includes a scarifying head 28 at the distal end thereof as shown.

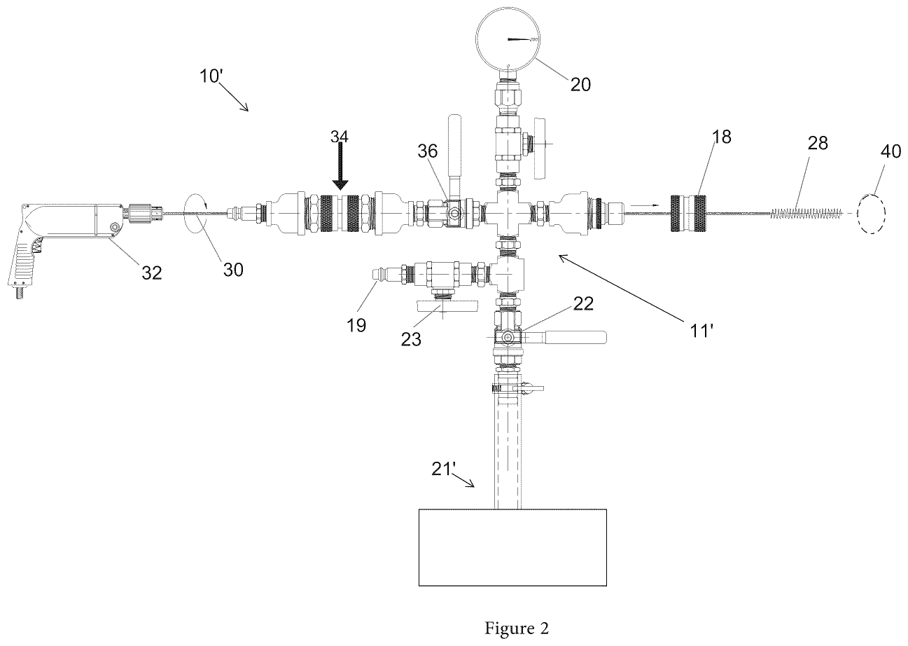

In particular embodiments, probe 30 is disposed in sliding-fit engagement with an access port 34 of housing 11, so that the probe, e.g., in the form of a flexible cable, is slidably extendable through the housing in a longitudinal direction as shown by arrow 37, to enable the distal end/head 28 to operatively engage blockages in drain 40. In various embodiments, the probe is also rotatable about its longitudinal axis, as shown at arrow 35, by a rotating driver such as a power drill 32 (FIG. 2). The probe and the scarifying head 28 are thus configured to move both axially and rotationally, as shown by arrows 37 and 35, respectively, to clear blockages in drain 40. The mechanical cleaning tool 30 and pressurized gas cleaning tool 19 may be used simultaneously or sequentially, to engage and clear blockages from the drain 40, while pressurized process fluid exiting from the drain as the blockages are cleared, is received and contained by the liquid capture assembly.

Turning now to FIG. 2, an alternate embodiment of the drain cleaning system of the present invention is shown at 10′ with a housing 11′, which are substantially similar to system and housing 10 and 11 as shown and described with respect to FIG. 1, with the following distinctions.

As shown, system 10′ is configured for use with an active process containing pressurized process fluid in the form of a chiller-based HVAC (Heating Ventilating and Air Conditioning) system. Housing 11′ includes a shut-off valve 36 disposed between the access port 34 and the process attachment fitting 18, so that when the valve is in its open position, the probe 30 is axially extendable through the shut-off valve to move scarifying head 28 into engagement with blockages in the drain 40. The probe 30 may then be axially retracted from the shut-off valve after the engagement to permit the valve 36 to be closed to block pressurized process fluid exiting the drain 40 from flowing to the access port after the blockages are cleared. Ball valve 36 may also be closed to permit a relatively high pressure charge of compressed gas (e.g., air) to be applied to the housing 11′ via fitting 19 to help fully unclog the blocked drain 40.

Quick-connect high-pressure gas (e.g., air) fitting 19 is connected via selectively openable and closable ball valve 23 to housing 11. Housing 11 also includes a fluid drain controlled by a selectively openable and closable ball valve 22 feeding the liquid capture assembly 21, and a pressure gauge 20, optionally connected via a ball valve, to measure pressure within the housing. In addition, access port 34 is optionally configured as a gasket assembly to help seal the probe 30 against fluid and air leakage during operation. It should also be recognized that the liquid capture assembly 21′ is disposed in operative fluid communication between the process attachment fitting 18 and the shut-off valve 36, so that process fluid exiting from the drain 40 flows in a downstream direction in the housing 11′ from the drain 40 to the liquid capture assembly 21′. It should also be noted that in various embodiments as shown, assembly 21′ is configured as a receptacle to capture and retain the exiting process fluid therein.

Embodiments of the present invention safely clear blockages in process piping as small as ¾-inch diameter, that is under significant pressure on the upstream side of the obstruction. These embodiments help ensure that once the obstruction is removed, there is substantially no uncontrolled discharge of process fluid from the HVAC or other process. In particular embodiments, this fluid control is maintained by gasket assembly 34 that forms a fluid-tight seal with the probe 30. Particular embodiments are configured to safely handle pressures upstream of the obstructions of up to 150 psi or more. In addition, the pressurized gas cleaning tool 19 provides exceptional clearing power that may be used in combination with the mechanical probe 30 to clear particularly stubborn blockages.

### Operation

A large percentage of drains 40 in commercial and institutional closed loop HVAC systems consist of ¾-inch diameter garden hose fittings that are controlled by either gate or ball valves. The relatively small diameter of these fittings, and the piping connecting these drain fittings to the main piping loop, make them particularly susceptible to blockage by accumulated hardened sludge and scale deposits. The embodiments shown and described herein may be operated as follows:
1. The drain cleaning system 10, 10′ is attached at fitting 18 to the blocked drain 40 by either threaded or cam lock fittings. All ball valves on the drain cleaning system are in their closed positions.
2. A high-pressure gas (e.g., air) source is connected to the quick-connect fitting 19. If it is suspected that the blockage may be removed by a charge of air, the charge may be applied, using the pressure gauge 20 to ensure that desired pressure levels within the drain cleaning system and/or components of the closed-loop process to which it is attached are not exceeded.
3. If the air charge clears the line, valve 22 is opened to confirm free flow of process fluid through drain 40. If free flow is present, the valves on the drain cleaning system 10, 10′ are closed, drain 40 is closed, and the drain cleaning system 10, 10′ is removed.
4. If the air charge was not sufficient to clear the obstruction, system drain 40 and valve 36 are opened, and the probe 30 is advanced until the blockage is engaged. The proximal end of probe 30 is engaged by a chuck of a power driver, e.g., power drill 32. Drain 22 of the drain cleaning system is opened.
5. Using relatively slow speed, drill 32 is used to rotate probe 30 about its axis as shown at 35 (FIG. 1), while also slowly advancing and retracting the probe 30 axially from the point of contact with the blockage. Flow from the drain cleaning tool into liquid capture assembly 21, 21′ indicates the blockage is penetrated.
6. The probe may then be withdrawn from housing 11, 11′, the valves 36 and 22 closed, and a charge of gas (air) applied to the system at 19 to clear any remaining blockage. Application of air charges may be alternated with opening of system drain 22 until flow continuously discharges from the drain 22 into liquid capture assembly 21, 21′. If necessary, steps 5 and 6 may be repeated.
7. Close the drain 40 and remove the drain cleaning system.

The present invention has been described in particular detail with respect to various possible embodiments, and those of skill in the art will appreciate that the invention may be practiced in other embodiments. First, the particular naming of the components, capitalization of terms, the attributes, or any other structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. It should be further understood that any of the features described with respect to one of the embodiments described herein may be similarly applied to any of the other embodiments described herein without departing from the scope of the present invention. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims. It should be further understood that any of the features described with respect to one of the embodiments described herein may be similarly applied to any of the other embodiments described herein without departing from the scope of the present invention.

Having thus described the invention, what is claimed is:

1. A drain cleaning system for use with a drain of an active process containing pressurized process fluid, the system comprising:
a housing couplable in a fluid-tight manner to the drain of the active system;
the housing supporting a mechanical cleaning tool and a pressurized gas cleaning tool, to engage and clear blockages from the drain; and
a liquid capture assembly coupled in a fluid-tight manner to the housing, the liquid capture assembly to receive and contain process fluid exiting from the drain during operation of the mechanical cleaning tool and/or the pressurized gas cleaning tool.

2. The system of claim 1, wherein:
the housing includes a process attachment fitting sized and shaped for fluid-tight engagement with the drain of the active process;
the pressurized gas cleaning tool includes a gas fitting sized and shaped for gas-tight engagement with a pressurized gas source; and
the housing further includes a drainage port operatively engaged in a fluid-tight manner with the liquid capture assembly.

3. The system of claim 2, wherein the mechanical cleaning tool comprises:
an elongated probe disposed in sliding-fit engagement with an access port of the housing, the probe being slidably extendable into the housing wherein a distal end of the probe is operatively engageable with the drain;
the distal end of the probe having a scarifying head; and
a proximal end of the probe being engageable by a rotating power driver;
wherein the scarifying head and pressurized gas engage and clear blockages from the drain, and process fluid exiting from the drain is received and captured by the liquid capture assembly.

4. The system of claim 3, wherein the probe comprises a flexible cable.

5. The system of claim 3, wherein the active process containing pressurized process fluid comprises a chiller-based HVAC system, and the housing further comprises a shut-off valve disposed between the access port and the process attachment fitting, wherein the probe is extendable through the shut-off valve to move scarifying head into engagement with blockages in the drain, and is retractable from the shut-off valve after said engagement to permit the valve to be closed to block process fluid exiting the drain from flowing to the access port after the blockages are cleared from the drain.

6. The system of claim 5, wherein the access port further comprises a gasket assembly to provide a fluid-tight seal with the probe.

7. The system of claim 5, further comprising the liquid capture assembly being disposed in operative fluid communication between the process attachment fitting and the shut-off valve, wherein fluid exiting from the drain flows in a downstream direction in the housing from the drain to the liquid capture assembly.

8. The system of claim 7, wherein the housing further comprises a pressure gauge to measure pressure within the housing.

9. The system of claim 8, wherein the gas fitting is selectively openable and closeable.

10. The system of claim 9, wherein the drainage port is selectively openable and closable.

11. A method for manufacturing a drain cleaning system for use with a drain of an active process containing pressurized process fluid, the method comprising:
(a) configuring a housing to be couplable in a fluid-tight manner to the drain of the active system;
(b) supporting, with the housing, a mechanical cleaning tool and a pressurized gas cleaning tool;
(c) configuring the mechanical cleaning tool and the pressurized gas cleaning tool to engage and clear blockages from the drain; and
(d) coupling in a fluid-tight manner to the housing, a liquid capture assembly, to receive and contain process fluid exiting from the drain during operation of the mechanical cleaning tool and/or the pressurized gas cleaning tool.

12. The method of claim 11, wherein the method further comprises:
providing the housing with a process attachment fitting sized and shaped for fluid-tight engagement with the drain of the active process;
providing the pressurized gas cleaning tool with a gas fitting sized and shaped for gas-tight engagement with a pressurized gas source; and
further providing the housing with a drainage port operatively engaged with the liquid capture assembly.

13. The method of claim 12, further comprising providing the mechanical cleaning tool with:
an elongated probe disposed in sliding-fit engagement with an access port of the housing, the probe being slidably extendable into the housing wherein a distal end of the drain snake is operatively engageable with the drain;
the distal end of the drain snake having a scarifying head; and
a proximal end of the drain snake being engageable by a rotating power driver;
wherein the scarifying head and pressurized gas engage and clear blockages from the drain, and process fluid exiting from the drain is received and captured by the liquid capture assembly.

14. The method of claim 13, further comprising configuring the probe as a flexible cable.

15. The method of claim 13, wherein the active process containing pressurized process fluid includes a chiller-based HVAC system, and the method further comprises disposing a shut-off valve in the housing between the access port and the process attachment fitting, wherein the probe is extendable through the shut-off valve to move scarifying head into engagement with blockages in the drain, and is retractable from the shut-off valve after said engagement to permit the valve to be closed to block process fluid exiting the drain from flowing to the access port after the blockages are cleared from the drain.

16. The method of claim 15, further comprising providing the access port with a gasket assembly to provide a fluid-tight seal with the probe.

17. The method of claim 15, further comprising disposing the liquid capture assembly in operative fluid communication between the process attachment fitting and the shut-off valve, wherein fluid exiting from the drain flows in a downstream direction in the housing from the drain to the liquid capture assembly.

18. The method of claim 17, further comprising disposing a pressure gauge on the housing to measure pressure within the housing.

19. The method of claim 18, further comprising configuring the gas fitting to be selectively openable and closeable.

20. The method of claim 19, further comprising configuring the drainage port to be selectively openable and closable.
